(19) United States
(12) Patent Application Publication
(10) Pub. No.: US 2026/0235157 A1
(43) Pub. Date: Aug. 13, 2026

(54) ELECTRONIC DEVICE ASSEMBLY AND BALL JOINT HOLDER THEREOF

(71) Applicant: Chicony Electronics Co., Ltd., New Taipei City (TW)

(72) Inventor: Tzu-Peng Wu, New Taipei City (TW)

(21) Appl. No.: 19/211,458

(22) Filed: May 19, 2025

(30) Foreign Application Priority Data
Feb. 7, 2025 (TW) 114104699

(51) Int. Cl. F16C 11/06

(52) U.S. Cl. CPC F16C 11/0695

(57) ABSTRACT

An electronic device assembly includes a ball joint holder, an electronic device, and a ball joint. The ball joint holder is adapted to be assembled with the ball joint and includes a fixing plate, an assembling member, and a ball joint supporting plate. The fixing plate has an assembling surface. The assembling member is disposed on the assembling surface of the fixing plate. The ball joint supporting plate includes a pivot side, a swingable side, and a slot. The pivot side is pivotally connected to the assembling surface of the fixing plate, allowing the ball joint supporting plate to swing relative to the fixing plate between an extended position and a folded position by taking the pivot side as a fulcrum, so that the assembling member is selectively assembled with the ball joint supporting plate.

### CROSS-REFERENCE TO RELATED APPLICATION

This non-provisional application claims priority under 35 U.S.C. § 119(a) to Patent Application No. 114104699 filed in Taiwan, R.O.C. on Feb. 7, 2025, the entire contents of which are hereby incorporated by reference.

### BACKGROUND

### Technical Field

The instant disclosure relates to a holder, in particular, to a ball joint holder and an electronic device assembly utilizing the ball joint holder.

### Related Art

Many electronic devices (e.g., cameras, speakers, or lights) are commonly installed on holders, so that the electronic devices can be positioned, and the orientations of the electronic devices can be adjusted according to different demands. During the assembling process, in general, the operator assembles the electronic device on an assembling region of the holder by bare hands.

### SUMMARY

However, for such assembling operation, certain risks may occur; if the operator cannot properly hold the electronic device during the assembling process, owing to improper operation or other external forces, the electronic device may lose support and fall, thereby causing the damage of the electronic device.

In view of this, in one embodiment, a ball joint holder is provided. The ball joint holder is adapted to be assembled with a ball joint, the ball joint comprises a joint rod and a ball body, the ball body is connected to one end of the joint rod, and the ball joint holder comprises a fixing plate, an assembling member, and a ball joint supporting plate. The fixing plate has an assembling surface. The assembling member is disposed on the assembling surface of the fixing plate. The ball joint supporting plate has a pivot side, a swingable side, and a slot. The slot is between the pivot side and the swingable side and is adapted to be inserted by the joint rod. The pivot side is pivotally connected to the assembling surface of the fixing plate, allowing the ball joint supporting plate to swing relative to the fixing plate between an extended position and a folded position by taking the pivot side as a fulcrum, so that the assembling member is selectively assembled with the ball joint supporting plate.

In another embodiment, an electronic device assembly is provided. The electronic device assembly comprises an aforementioned ball joint holder, an electronic device, and a ball joint. The electronic device comprises a housing. The ball joint comprises a joint rod and a ball body, the ball body is connected to one end of the joint rod, the other end of the joint rod is connected to the housing, and the ball joint holder is adapted to be assembled with the ball joint.

As above, according to one or some embodiments of the instant disclosure, during the process of assembling the ball joint with the ball joint holder, the ball joint supporting plate can swing relative to the fixing plate to the extended position, so that the joint rod of the ball joint can be quickly inserted into the slot of the ball joint supporting plate, and the joint rod can be limited on the ball joint supporting plate in advance. Next, the ball joint supporting plate then can swing relative to the fixing plate to the folded position, so that the ball joint supporting plate can be assembled with the ball joint through the assembling member. Therefore, the electronic device can be prevented from falling during the assembling process, thereby greatly enhancing the assembling safety and convenience.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of an electronic device assembly according to an exemplary embodiment of the instant disclosure;

FIG. 2 illustrates an exploded view of the electronic device assembly of the exemplary embodiment of the instant disclosure;

FIG. 3 illustrates a partial cross-sectional view of the electronic device assembly of the exemplary embodiment of the instant disclosure;

FIG. 4 illustrates a schematic assembled view of an electronic device and a ball joint holder according to an exemplary embodiment of the instant disclosure;

FIG. 5 illustrates a schematic assembled view followed by FIG. 4;

FIG. 6 illustrates a schematic assembled view followed by FIG. 5;

FIG. 7 illustrates a schematic assembled view followed by FIG. 6;

FIG. 8 illustrates an enlarged partial view of the electronic device assembly of the exemplary embodiment of the instant disclosure;

FIG. 9 illustrates a schematic assembled view of an electronic device and a ball joint holder according to another exemplary embodiment of the instant disclosure;

FIG. 10 illustrates a schematic assembled view followed by FIG. 9; and

FIG. 11 illustrates a schematic assembled view followed by FIG. 10.

### DETAILED DESCRIPTION

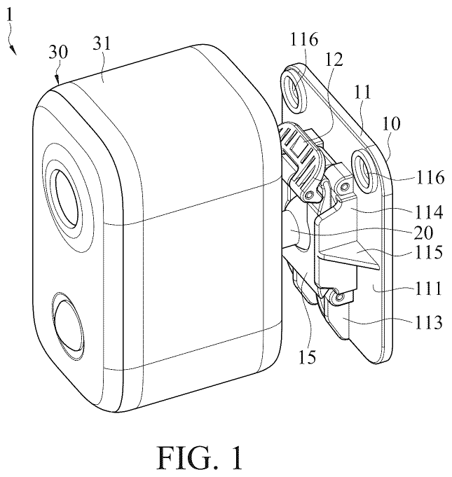

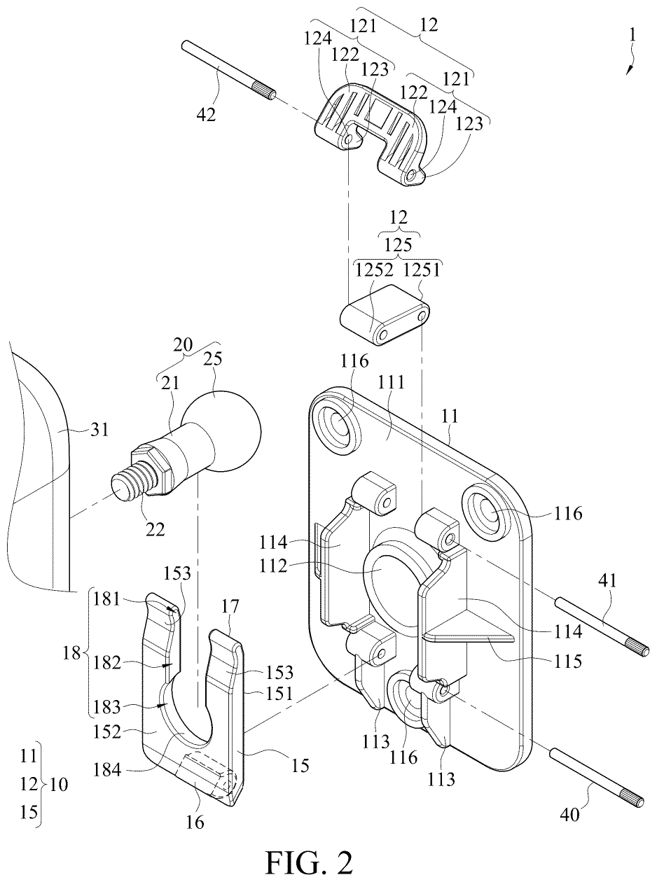

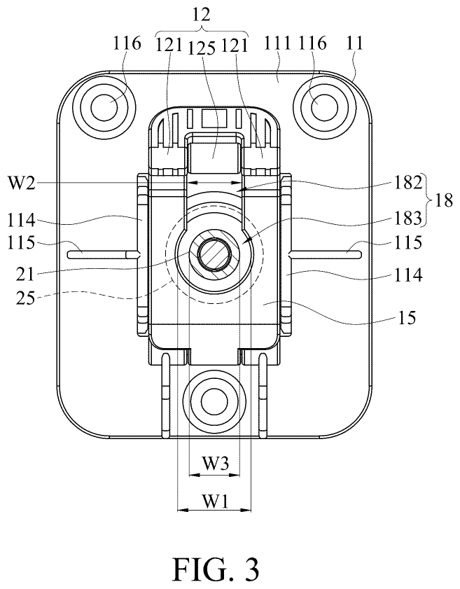

FIG. 1 illustrates a perspective view of an electronic device assembly according to an exemplary embodiment of the instant disclosure. FIG. 2 illustrates an exploded view of the electronic device assembly of the exemplary embodiment of the instant disclosure. FIG. 3 illustrates a partial cross-sectional view of the electronic device assembly of the exemplary embodiment of the instant disclosure. As shown in FIG. 1 to FIG. 3, in this embodiment, the electronic device assembly 1 comprises a ball joint holder 10, a ball joint 20, and an electronic device 30, where the electronic device 30 may be a camera, a speaker, a light, or other electronic products.

As shown in FIG. 1 to FIG. 3, the ball joint 20 is adapted to be assembled on the electronic device 30, so that the electronic device 30 can be assembled with the ball joint holder 10 through the ball joint 20. In this embodiment, the ball joint 20 comprises a joint rod 21 and a ball body 25, and the ball body 25 is connected to one of two ends of the joint rod 21. For example, the ball body 25 may be integrally connected to the end portion of the joint rod 21, so that the ball body 25 and the joint rod 21 together form a one-piece structure; alternatively, in some embodiments, the ball body 25 and the joint rod 21 may be an assembled structure, but the instant disclosure is not limited thereto. The other end of the joint rod 21 is connected to a housing 31 of the electronic device 30. In this embodiment, the joint rod 21 of the ball joint 20 is fixed on the housing 31 through a fixing member 22. For example, the fixing member 22 may be a rivet, a screw, a bolt, or the like, but the instant disclosure is not limited thereto; in some embodiments, the end portion of the joint rod 21 away from the ball body 25 may be fixed on the housing 31 of the electronic device 30 through screwing, engaging, adhering, or other manners; in some other embodiments, the joint rod 21 of the ball joint 20 and the electronic device 30 may be integrally formed as a one-piece structure.

As shown in FIG. 1 to FIG. 3, the ball joint holder 10 comprises a fixing plate 11, an assembling member 12, and a ball joint supporting plate 15, where the fixing plate 11 is adapted to be installed on a fixed surface (such as the wall, the ceiling, the floor, or the surface of a vehicle). In this embodiment, the fixing plate 11 comprises an assembling surface 111, and the assembling surface 111 may comprise one or more assembling portions 116 (in this embodiment, the assembling surface 111 comprises a plurality of the assembling portions 116); for example, the assembling portion 116 may be a hole, so that the assembling portion 116 is fixed on the fixed surface through a rivet, a screw, or a bolt.

As shown in FIG. 1 to FIG. 3, the assembling surface 111 of the fixing plate 11 has an inner groove 112, and the inner groove 112 is adapted to be assembled with the ball body 25 of the ball joint 20. In this embodiment, the inner groove 112 is a semispherical groove, and an inner surface curvature of the inner groove 112 corresponds to a surface curvature of the ball body 25. Therefore, after the ball body 25 is assembled in the inner groove 112, the ball body 25 can be moved relative to the inner groove 112 with improved smoothness. In some embodiments, the surface of the ball body 25 and the inner surface of the inner groove 112 may contact each other to generate a friction; when the ball joint 20 is moved relative to the inner groove 112, the friction between the ball body 25 and the inner groove 112 can effectively prevent the ball body 25 from keeping moving. Therefore, the ball joint 20 can be stably positioned at the adjusted orientation after the movement of the ball joint 20.

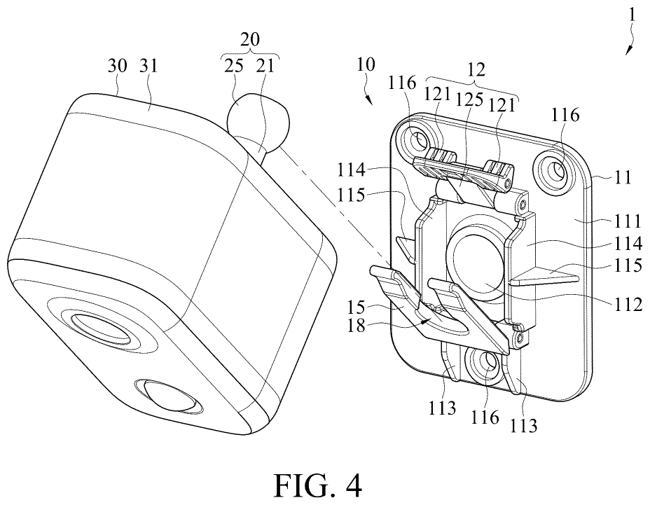

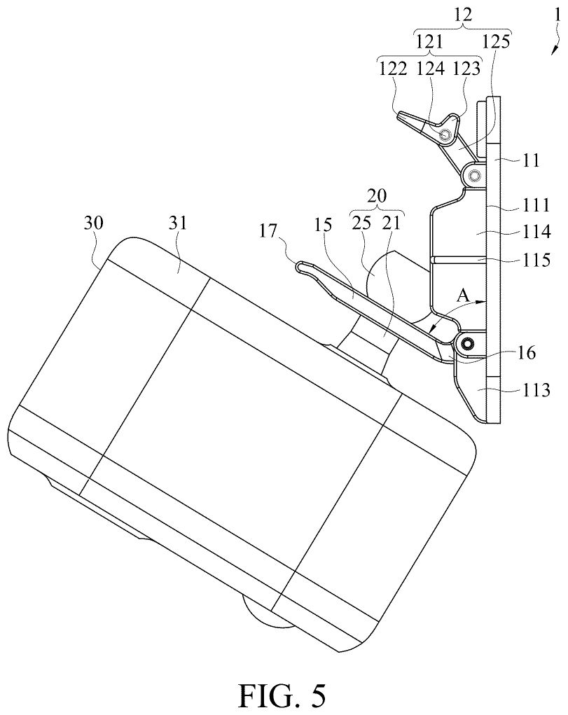

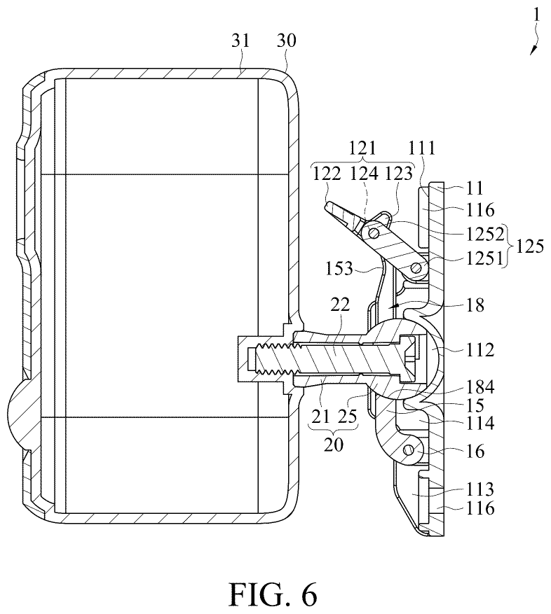

FIG. 4 illustrates a schematic assembled view of an electronic device and a ball joint holder according to an exemplary embodiment of the instant disclosure. FIG. 5 illustrates a schematic assembled view followed by FIG. 4. FIG. 6 illustrates a schematic assembled view followed by FIG. 5. As shown in FIG. 1 to FIG. 6, the ball joint supporting plate 15 has a pivot side 16, a swingable side 17, and a slot 18. The pivot side 16 is pivotally connected to the assembling surface 111 of the fixing plate 11, allowing the ball joint supporting plate 15 to swing relative to the fixing plate 11 between an extended position (the position shown in FIG. 4 and FIG. 5) and a folded position (the position shown in FIG. 1 and FIG. 6) by taking the pivot side 16 as a fulcrum, so that the distance between the swingable side 17 and the assembling surface 111 of the fixing plate 11 can be varied. In this embodiment, the pivot side 16 of the ball joint supporting plate 15 is pivotally connected to the assembling surface 111 through a shaft 40 (as shown in FIG. 2), but the instant disclosure is not limited thereto.

As shown in FIG. 1 to FIG. 3, the slot 18 of the ball joint supporting plate 15 is between the pivot side 16 and the swingable side 17 and is adapted to be inserted by the joint rod 21 of the ball joint 20, and a maximum width W1 of the slot 18 is less than a diameter of the ball body 25 of the ball joint 20. Therefore, after the joint rod 21 of the ball joint 20 is inserted into the slot 18, the ball body 25 can be prevented from detaching off the ball joint supporting plate 15, so that the ball joint 20 can be assembled on the ball joint supporting plate 15 and the ball joint 20 can be limited on the ball joint supporting plate 15.

As shown in FIG. 4 and FIG. 5, during assembling the electronic device 30 equipped with the ball joint 20 onto the ball joint holder 10, the operator first swings the ball joint supporting plate 15 relative to the fixing plate 11 to the extended position. When the ball joint supporting plate 15 is in the extended position, an inclined angle A is between the ball joint supporting plate 15 and the fixing plate 11. Under such configuration, the operator can hold the electronic device 30 by hand, place the ball body 25 of the ball joint 20 of the electronic device 30 into the space between the ball joint supporting plate 15 and the fixing plate 11 easily, and insert the joint rod 21 of the ball joint 20 into the slot 18 of the ball joint supporting plate 15. Therefore, the electronic device 30 can be limited on the ball joint supporting plate 15 in advance (as shown in FIG. 5). Hence, during the process that the electronic device 30 is limited on the ball supporting plate 15 in advance, the operator does not need to use any tool or conduct any complicated operation procedure, thereby greatly reducing the possibility of the falling of the electronic device 30. Moreover, during the subsequent assembling process, the operator does not need to hold the electronic device 30 by hand. Therefore, the electronic device 30 can be prevented from falling during the assembling process, thereby greatly enhancing the assembling safety and convenience.

In some embodiments, the inclined angle A between the ball joint supporting plate 15 and the fixing plate 11 may be determined according to actual product demands. For example, the larger the diameter of the ball body 25 of the ball joint 20, the larger the inclined angle A between the ball joint supporting plate 15 and the fixing plate 11. Therefore, the ball body 25 can be properly placed into the space between the ball joint supporting plate 15 and the assembling surface 111.

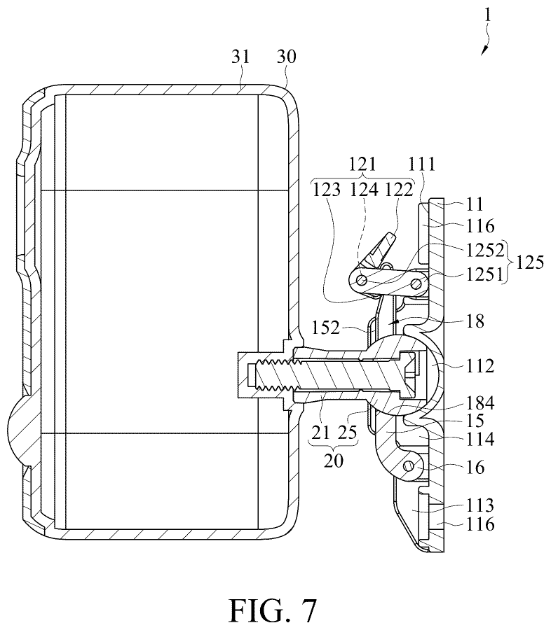

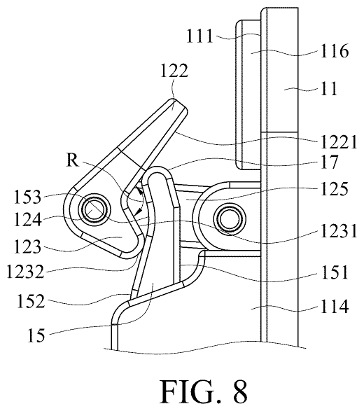

As shown in FIG. 2 to FIG. 6, the assembling member 12 is disposed on the assembling surface 111 of the fixing plate 11 and is adapted to be assembled with the ball joint supporting plate 15. For example, the assembling member 12 and the ball joint supporting plate 15 may be assembled with each other through engaging or screwing, so that the assembling member 12 and the ball joint supporting plate 15 still can be detached from each other after the assembling. When the ball joint 20 on the electronic device 30 is limited on the ball joint supporting plate 15 in advance (as shown in FIG. 5), the operator can apply force to push the ball joint supporting plate 15 to move toward the assembling surface 111 of the fixing plate 11 gradually, so that the ball joint supporting plate 15 swings from the extended position to the folded position (as shown in FIG. 6), and the ball joint supporting plate 15 then drives the electronic device 30 and the ball joint 20 to move toward the fixing plate 11. When the ball joint supporting plate 15 is in the folded position, the position of the slot 18 of the ball joint supporting plate 15 corresponds to the position of the inner groove 112, so that the ball body 25 of the ball joint 20 can be correspondingly assembled in the inner groove 112. Next, as shown in FIG. 7 and FIG. 8, the operator can operate the assembling member 12 to be assembled with the ball joint supporting plate 15, so that the ball joint supporting plate 15 as well as the electronic device 30 are assembled on the fixing plate 11, and the orientation of the electronic device 30 can be adjusted through the ball joint 20.

Moreover, when the electronic device 30 need to be detached from the ball joint holder 10, the operator can operate the assembling member 12 to release the ball joint supporting plate 15, so that the ball joint supporting plate 15 swings away from the fixing plate 11, and the ball joint supporting plate 15 swings from the folded position (the position shown in FIG. 6) toward the extended position (the position shown in FIG. 5). Furthermore, during the operation of the ball joint supporting plate 15, the electronic device 30 is still limited on the ball joint supporting plate 15 through the ball joint 20. Therefore, the operator also does not need to hold the electronic device 30 by hand, and the electronic device 30 can be prevented from falling during the assembling process. Next, when the ball joint supporting plate 15 is in the extended position, the operator can then hold the electronic device 30 by hand and detach the ball joint 20 from the slot 18 of the ball joint supporting plate 15 easily to achieve the detachment procedure. Accordingly, the safety and convenience for the detachment procedure can be greatly enhanced.

As shown in FIG. 2 to FIG. 4, in this embodiment, the slot 18 of the ball joint supporting plate 15 has an insertion opening 181, a guiding groove 182, and a ball body accommodation groove 183. The insertion opening 181 is at the swingable side 17, and the insertion opening 181 and the ball body accommodation groove 183 are in communication with each other through the guiding groove 182. A width W2 of the guiding groove 182 is less than the width W1 of the ball body accommodation groove 183, the width W2 of the guiding groove 182 is greater than a width W3 of the joint rod 21 of the ball joint 20, and the width W1 of the ball body accommodation groove 183 is less than the diameter of the ball body 25 of the ball joint 20. Therefore, as shown in FIG. 4 and FIG. 5, during the process of assembling the electronic device 30 with the ball joint holder 10, when the ball joint supporting plate 15 is in the extended position, the operator can insert the joint rod 21 of the ball joint 20 on the electronic device 30 into the slot 18 through the insertion opening 18, so that the joint rod 21 enters the ball body accommodation groove 183 along the guiding groove 182. Next, after the operator releases the electronic device 30, the ball body 25 is limited in the ball body accommodation groove 183, so that the electronic device 30 is limited on the ball joint supporting plate 15 in advance. Moreover, the width W3 of the joint rod 21 of the ball joint 20 is less than the width W1 of the ball body accommodation groove 183. Therefore, when the ball body 25 is moved relative to the inner groove 112 to adjust the orientation of the electronic device 30, the slot 18 provides enough room for the joint rod 21 to swing. However, it is understood that, the foregoing embodiments are provided for illustrative purposes; in some embodiments, the insertion opening 181 of the slot 18 may be at different sides of the ball joint supporting plate 15, and the slot 18 may be designed to have different shapes according to actual product demands.

As shown in FIG. 2 and FIG. 6, in this embodiment, the ball body accommodation groove 183 has an inner annular surface 184, and a surface curvature of the inner annular surface 184 may correspond to the surface curvature of the ball body 25. Therefore, when the ball body 25 is limited in the ball body accommodation groove 183, the inner annular surface 184 closely contacts the surface of the ball body 25. Hence, during the process that the ball body 25 is moved relative to the inner groove 112, wobbling of the ball body 25 can be prevented and the movement of the ball body 25 can be conducted more stably.

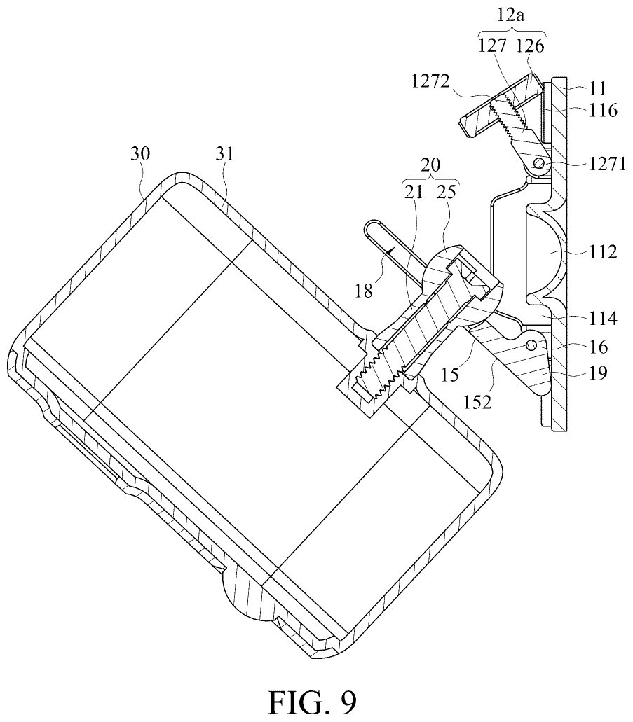

In some embodiments, the fixing plate 11 or the ball joint supporting plate 15 may be provided with a stopping component. Therefore, when the ball joint supporting plate 15 is in the extended position and the inclined angle A is between the ball joint supporting plate 15 and the fixing plate 11 (as shown in FIG. 5), the inclined angle A can be retained through the stopping component. For example, as shown in FIG. 2, FIG. 4, and FIG. 5, the assembling surface 111 of the fixing plate 11 may be provided with one or more stopping members 113. In this embodiment, the stopping members 113 are plates and the number of the stopping members 113 is two, the two stopping members 113 are perpendicular to the fixing plate 11 and spaced apart from each other. When the ball joint supporting plate 15 is in the extended position, the ball joint supporting plate 15 leans against the two stopping members 113 to retain the inclined angle A. In one embodiment, the stopping member 113 may lean against the pivot side 16 of the ball joint supporting plate 15 (as shown in FIG. 5) to limit the rotation range of the pivot side 16. Therefore, when the ball joint supporting plate 15 swings to the extended position, the pivot side 16 cannot rotate anymore. Alternatively, in another embodiment, as shown in FIG. 9, a stopping member 19 may be provided on the ball joint supporting plate 15; in this embodiment, the stopping member 19 integrally extends from the pivot side 16 of the ball joint supporting plate 15. Therefore, when the ball joint supporting plate 15 is in the extended position, the stopping member 19 leans against the fixing plate 11 to retain the inclined angle A.

As shown in FIG. 1 to FIG. 4, in this embodiment, the assembling surface 111 of the fixing plate 11 is provided with two limiting plates 114 and two reinforcement plates 115. The two limiting plates 114 are perpendicular to the fixing plate 11 and spaced apart from each other. When the ball joint supporting plate 15 is in the folded position, the ball joint supporting plate 15 is limited between the two limiting plates 114. Therefore, during the process that the ball joint 20 is moved relative to the inner groove 112, displacement or deformation of the ball joint supporting plate 15 can be prevented. The two reinforcement plates 115 are perpendicular to the fixing plate 11 and respectively connected to the two limiting plates 114. Therefore, the overall structural strength of the ball joint holder 10 and the performance of the two limiting plates 114 for limiting the ball joint supporting plates 15 can be enhanced. In one embodiment, the two reinforcement plates 115 are respectively perpendicular to the two limiting plates 114.

As shown in FIG. 2, FIG. 7, and FIG. 8, in this embodiment, the ball joint supporting plate 15 has an inner surface 151 and an outer surface 152, and the inner surface 151 faces the fixing plate 11. When the ball joint supporting plate 15 is in the folded position, the assembling member 12 is assembled and fixed on the outer surface 152, so that the ball joint supporting plate 15 is assembled on the fixing plate 11, but the instant disclosure is not limited thereto; in some embodiments, the assembling member 12 may be assembled on any other position of the ball joint supporting plate 15.

As shown in FIG. 2 and FIG. 6 to FIG. 8, the outer surface 152 of the ball joint supporting plate 15 may have at least one engaging groove 153, the assembling member 12 may comprise at least one engaging member 121, and the engaging member 121 is adapted to be engaged with the engaging groove 153. In some embodiments, the number of the engaging members 121 and the number of the engaging grooves 153 may correspond to each other, for example, both of the number of the engaging members 121 and the number of the engaging grooves 153 may be one or two; alternatively, in some other embodiments, the number of the engaging grooves 153 may be plural, the number of the engaging member 121 may be one, and the engaging member 121 may be adapted to be engaged with the engaging grooves 153 at the same time; in yet some other embodiments, the number of the engaging groove 153 may be one, the number of the engaging members 121 may be plural, and the engaging members 121 may be adapted to be engaged with the engaging groove 153 at the same time, but the instant disclosure is not limited thereto.

As shown in FIG. 2 and FIG. 6 to FIG. 8, in this embodiment, the number of the engaging grooves 153 of the ball joint supporting plate 15 is two, the two engaging grooves 153 are respectively at two opposite sides of the slot 18, the assembling member 12 comprises two engaging members 121 and a connection member 125, the connection member 125 has a first end 1251 and a second end 1252 opposite to the first end 1251, and the first end 1251 is pivotally connected to the fixing plate 11; for example, the first end 1251 of the connection member 125 can be pivotally connected to the fixing plate 11 through a shaft 41, so that the connection member 125 can swing relative to the fixing plate 11 by taking the first end 1251 as a fulcrum.

As shown in FIG. 2 and FIG. 6 to FIG. 8, the two engaging members 121 of the assembling members 12 are pivotally connected to the second end 1252 of the connection member 125, respectively; for example, each of the engaging members 121 is pivotally connected to the second end 1252 of the connection member 125 through a shaft 42, so that each of the engaging members 121 can be rotated relative to the connection member 125, and each of the engaging members 121 is assembled in a corresponding one of the engaging grooves 153 of the ball joint supporting plate 15 through rotation. Specifically, in some embodiments, when the ball joint 20 on the electronic device 30 is limited on the ball joint supporting plate 15 in advance and swings from the extended position to the folded position (as shown in FIG. 6), the operator can first operate the connection member 125 of the assembling member 12 to swing relative to the fixing plate 11, so that the connection member 125 can be inserted into the slot 18 of the ball joint supporting plate 15. Next, the operator rotates the engaging member 121 relative to the connection member 125, so that each of the engaging members 121 is assembled in the corresponding one of the engaging grooves 153 of the ball joint supporting plate 15 and fixed on the outer surface 152 of the ball joint supporting plate 15. Moreover, during the rotation of the engaging members 121 relative to the connection member 125, the engaging members 121 may lean against the swingable side 17 of the ball joint supporting plate 15 to cause the ball joint supporting plate 15 to deform slightly. Therefore, each of the engaging members 121 can enter and be engaged with the corresponding one of the engaging grooves 153 properly.

As shown in FIG. 2, FIG. 7, and FIG. 8, in this embodiment, each of the engaging members 121 comprises a first engaging plate 122, a second engaging plate 123, and a pivoting portion 124, the pivoting portion 124 is between the first engaging plate 122 and the second engaging plate 123, and the first engaging plates 122 of the two engaging members 121 are connected to each other (as shown in FIG. 2), so that the two engaging members 121 can be operated by the user at the same time, but the instant disclosure is not limited thereto. In some embodiments, the two engaging members 121 may be individual components. For each of the first engaging members 121, the extension direction of the first engaging plate 122 is different from the extension direction of the second engaging plate 123, and an angle R is between the first engaging plate 122 and the second engaging plate 123; in this embodiment, the angle R between the first engaging plate 122 and the second engaging plate 123 is an obtuse angle, but the instant disclosure is not limited thereto. The pivoting portion 124 of the engaging member 121 is pivotally connected to the second end 1252 of the connection member 125; for example, the pivoting portion 124 may be pivotally connected to the second end 1252 of the connection member 125 through a shaft 42 (as shown in FIG. 2). The first engaging plate 122 has a first side surface 1221, the second engaging plate 123 has a second side surface 1231; in this embodiment, the second side surface 1231 is the surface between the end portion 1232 of the second engaging plate 123 and the first side surface 1221. When the engaging member 121 is assembled in the engaging groove 153, the first side surface 1221 of the first engaging plate 122 may lean against the swingable side 17 of the ball joint supporting plate 15, and the second side surface 1231 of the second engaging plate 123 may lean against the outer surface 152 of the ball joint supporting plate 15. Therefore, through the specific engaging configuration, upon the engaging member 121 is pressed by the ball joint supporting plate 15, rotation of the engaging member 121 can be prevented, thereby enhancing the fixing performance of the engaging member 121.

However, it is understood that, the foregoing embodiments are provided for illustrative purposes; in one embodiment, for the engaging member 121, the end portion 1232 of the second engaging plate 123 or a portion nearby the end portion 1232 leans against the engaging groove 153 of the ball joint supporting plate 15, and the first side surface 1221 of the first engaging plate 122 leans against the swingable side 17 of the ball joint supporting plate 15. Therefore, both in a first direction (the counterclockwise direction according to the viewing angle shown in FIG. 8) or in a second direction (the clockwise direction according to the viewing angle shown in FIG. 8), the second engaging plate 123 is limited in the engaging groove 153 due to the curvature of the engaging groove 153, so that the engaging member 121 does not detach from the ball joint supporting plate 15 easily. On the other hand, in the second direction (the clockwise direction according to the viewing angle shown in FIG. 8), because the first engaging plate 122 leans against the ball joint supporting plate 15, the second engaging plate 123 is further limited, so that the second engaging plate 123 can be engaged in the engaging groove 153 more stably.

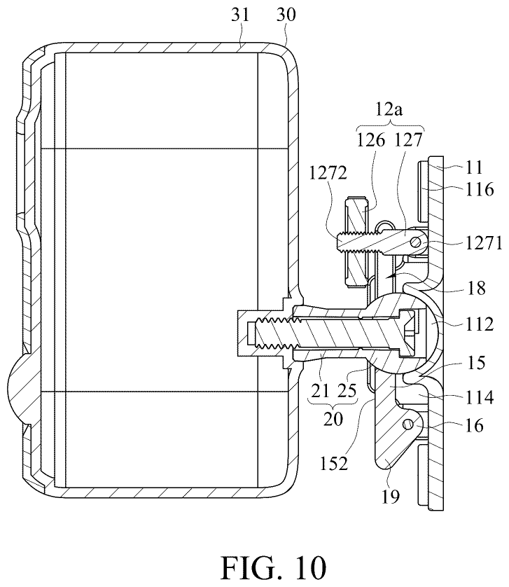

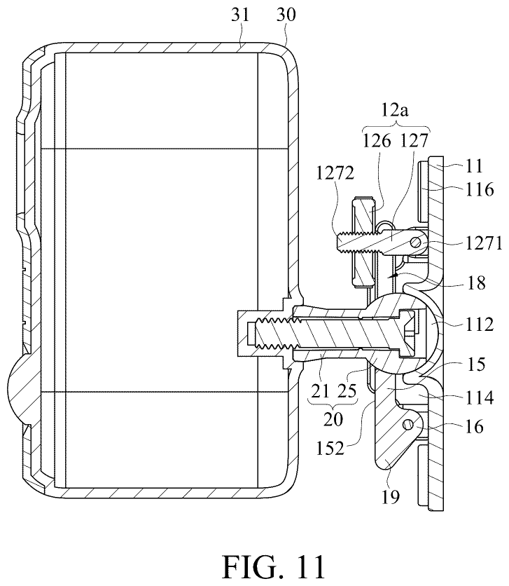

FIG. 9 illustrates a schematic assembled view of an electronic device and a ball joint holder according to another exemplary embodiment of the instant disclosure. FIG. 10 illustrates a schematic assembled view followed by FIG. 9. FIG. 11 illustrates a schematic assembled view followed by FIG. 10. As shown in FIG. 9 to FIG. 11, the difference between this embodiment and the embodiment shown in FIG. 5 to FIG. 7 at least lies in that, in this embodiment, the assembling member 12a comprises a locking member 126 and a connection member 127, the connection member 127 has a pivot end 1271 and a swing end 1272, the pivot end 1271 is pivotally connected to the fixing plate 11, so that the connection member 127 can swing relative to the fixing plate 11 by taking the pivot end 1271 as a fulcrum. The locking member 126 is disposed at the swing end 1272 of the connection member 127; in this embodiment, the locking member 126 is a screw and screwed with the swing end 1272 of the connection member 127, so that the locking member 126 can be rotated relative to the connection member 127.

Accordingly, as shown in FIG. 9 to FIG. 11, when the ball joint 20 on the electronic device 30 is limited on the ball joint supporting plate 15 in advance and swings from the extended position to the folded position, the operator can first operate the connection member 127 of the assembling member 12a to swing relative to the fixing plate 11, so that the connection member 127 can be inserted into the slot 18 of the ball joint supporting plate 15. Next, the operator rotates the locking member 126 relative to the connection member 127, so that the locking member 126 is locked on the outer surface 152 of the ball joint supporting plate 15.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A ball joint holder adapted to be assembled with a ball joint, wherein the ball joint
comprises a joint rod and a ball body, and the ball body is connected to one end of the ball joint rod, and wherein the ball joint holder comprises:
a fixing plate having an assembling surface;
an assembling member disposed on the assembling surface of the fixing plate; and
a ball joint supporting plate having a pivot side, a swingable side, and a slot, wherein the slot is between the pivot side and the swingable side and is adapted to be inserted by the joint rod, and the pivot side is pivotally connected to the assembling surface of the fixing plate, allowing the ball joint supporting plate to swing relative to the fixing plate between an extended position and a folded position by taking the pivot side as a fulcrum, so that the assembling member is selectively assembled with the ball joint supporting plate.

2. The ball joint holder according to claim 1, wherein the assembling surface of the fixing plate has an inner groove, and the inner groove is adapted to be assembled with the ball body.

3. The ball joint holder according to claim 1, wherein when the ball joint supporting plate is in the folded position, the assembling member is selectively assembled with the ball joint supporting plate.

4. The ball joint holder according to claim 1, wherein the slot of the ball joint supporting plate has an insertion opening, a guiding groove, and a ball body accommodation groove, the insertion opening is at the swingable side, and the insertion opening and the ball body accommodation groove are in communication with each other through the guiding groove.

5. The ball joint holder according to claim 4, wherein the ball body accommodation groove has an inner annular surface, and a surface curvature of the inner annular surface corresponds to a surface curvature of the ball body.

6. The ball joint holder according to claim 1, wherein when the ball joint supporting plate is in the extended position, an inclined angle is between the ball joint supporting plate and the fixing plate.

7. The ball joint holder according to claim 6, wherein the assembling surface of the fixing plate is provided with a stopping member, and when the ball joint supporting plate is in the extended position, the ball joint supporting plate leans against the stopping member to retain the inclined angle.

8. The ball joint holder according to claim 6, wherein the ball joint supporting plate is provided with a stopping member, and when the ball joint supporting plate is in the extended position, the stopping member leans against the fixing plate to retain the inclined angle.

9. The ball joint holder according to claim 1, wherein the assembling surface of the fixing plate is provided with two limiting plates spaced apart from each other, and when the ball joint supporting plate is in the folded position, the ball joint supporting plate is between the two limiting plates.

10. The ball joint holder according to claim 9, wherein the assembling surface of the fixing plate is provided with two reinforcement plates, and the two reinforcement plates are respectively connected to the two limiting plates.

11. The ball joint holder according to claim 1, wherein the ball joint supporting plate has an inner surface and an outer surface, the inner surface faces the fixing plate, and when the ball joint supporting plate is in the folded position, the assembling member is selectively assembled and fixed on the outer surface.

12. The ball joint holder according to claim 11, wherein the outer surface of the ball joint supporting plate has an engaging groove, the assembling member comprises an engaging member and a connection member, the connection member has a first end and a second end opposite to the first end, the first end is pivotally connected to the fixing plate, and the engaging member is pivotally connected to the second end; when the assembling member is assembled and fixed on the outer surface, the engaging member is assembled in the engaging groove, and the connection member is in the slot.

13. The ball joint holder according to claim 12, wherein the engaging member comprises a first engaging plate, a second engaging plate, and a pivoting portion, the pivoting portion is between the first engaging plate and the second engaging plate, and the pivoting portion is pivotally connected to the second end of the connection member; when the engaging member is assembled in the engaging groove, the first engaging plate leans against the swingable side of the ball joint supporting plate, and the second engaging plate leans against the outer surface of the ball joint supporting plate.

14. The ball joint holder according to claim 11, wherein the assembling member comprises a locking member and a connection member, the connection member has a pivot end and a swing end opposite to the pivot end, the pivot end is pivotally connected to the fixing plate, and the locking member is disposed at the swing end and adapted to be locked on the outer surface.

15. An electronic device assembly comprising:
a ball joint holder according to claim 1;
an electronic device comprising a housing; and
a ball joint comprising a joint rod and a ball body, wherein the ball body is connected to one of two ends of the joint rod, the other end of the joint rod is connected to the housing, and the ball joint holder is adapted to be assembled with the ball joint.
